(19) United States
(12) Patent Application Publication
(10) Pub. No.: US 2017/0014936 A1
(43) Pub. Date: Jan. 19, 2017

(54) WELD PROTECTING DEVICE BY GAS DIFFUSION

(71) Applicant: AIRBUS OPERATIONS (S.A.S.), Toulouse (FR)

(72) Inventors: Stéphane PERNODET, Toulouse (FR); David RIPOLL, Toulouse (FR); Pierre TABOURIECH, Castelginest (FR)

(21) Appl. No.: 15/210,490

(22) Filed: Jul. 14, 2016

(30) Foreign Application Priority Data
Jul. 15, 2015 (FR) 15 56678

(51) Int. Cl. B23K 9/32; B23K 9/16; B23K 9/02

(52) U.S. Cl. CPC B23K 9/325; B23K 9/02; B23K 9/16

(57) ABSTRACT

A weld protecting device by gas diffusion including several elements mounted one after the other and hinged to each other, and including a front element, intermediate elements mounted one after the other and behind the front element. A back element is mounted behind the last intermediate element, each element including a housing open downwards and towards each other adjacent element, forming a gas diffusion chamber, wherein two adjacent elements are hinged to each other and they are free to pivot relative to each other, regardless of the operating conditions of the protecting device. A facility for welding two opposite edges of two pieces, a weld protecting device, and a system for guiding the protecting device are disclosed.

### CROSS-REFERENCE TO RELATED APPLICATION

This application claims priority to French patent application FR 15 56678 filed Jul. 15, 2015, the entire disclosure of which is incorporated by reference herein.

### TECHNICAL FIELD

The disclosure herein relates to a weld protecting device by gas diffusion for diffusing on a weld bead a protective gas stream preventing any oxidization of the material making up the weld bead.

The disclosure herein more particularly relates to a device for diffusing a gas stream on a weld bead having a non rectilinear shape.

### BACKGROUND

Upon welding two pieces, for example by a TIG (Tungsten Inert Gas) welding or plasma arc welding method, the molten material is protected by an inert gas preventing its quick oxidization.

Generally speaking, the inert gas is fed by the welding head, thus protecting the zone where diffusion takes place.

It is sometimes necessary to protect the weld bead part which has just been made and is located in proximity to the zone where diffusion takes place.

This protection is implemented by a protecting device which covers a section of the weld bead and which moves on the weld bead, by following the welding head.

This protecting device, commonly referred to as a “saddle”, consists of or comprises an elongate element which extends above the weld bead and which delimits a cavity open towards the weld bead, through which the inert gas is sprayed on the weld bead.

EP-A-0.452.213 describes a protecting device designed to protect a flat or circular weld bead.

This protecting device includes several elements hinged to each other and the relative position of the elements of which is locked in use, in order to keep a configuration adapted to the geometry of the weld to be made.

Such a protecting device can thus be used to weld flat elements or for the internal or external welding of cylindrical elements.

However, some welds are made according to neither rectilinear nor circular geometries, to which such a protecting device cannot be applied.

### SUMMARY

A purpose of the disclosure herein is to provide a protecting device being able to adapt to any weld geometry.

The disclosure herein relates to a weld protecting device by Gas Diffusion including several elements mounted one after the other and hinged to each other, and including, from the front end to the back end according to the alignment of the elements: a front element which is intended to accommodate a welding head; intermediate elements mounted one after the other and behind the front element, a back element which is mounted behind the last intermediate element, each element including a housing open downwards and towards every other adjacent element, all the housings forming a gas diffusion chamber which is connected to a gas supply source, wherein two adjacent elements are hinged to each other and they are free to pivot relative to each other, regardless of the operating conditions of the protecting device.

The hinge of the elements making up the protecting device enables the position of the elements relative to each other to be modified and this enables the protecting device to be used for any weld geometry.

Furthermore, the lack of element locking enables the configuration of the protecting device to be easily adapted upon welding.

Preferably, the two adjacent elements are hinged to each other by a swivel connection, and are free to pivot relative to each other along any direction.

The swivel connection of both adjacent elements allows them to be relatively moved in every direction.

Preferably, a first element among two adjacent elements includes a hemispherical housing which is open towards the second element of the two adjacent elements and the second element includes an insert having a hemispherical shape complementary to the hemispherical housing of the first element, and the insert is accommodated in the hemispherical housing of the first element.

Preferably, a first end of each intermediate element includes a hemispherical housing and the second end of the intermediate element includes a hemispherical shaped insert.

Preferably, the front element includes a hemispherical housing in which an insert of the adjacent intermediate element is accommodated and the back element includes an insert which is accommodated in the hemispherical housing of the adjacent intermediate element.

Preferably, the protecting device includes structure for holding the insert of each element in the hemispherical housing of the adjacent element.

Preferably, the protecting device includes at least one link-forming cable which is attached to the front element and to the back element and which cooperates with each intermediate element, to prevent any forward or backward deviation of the elements from each other.

Preferably, the protecting device includes two cables vertically offset from each other, each end of each cable is attached to the front element or to the back element and a segment of each cable is connected to an intermediate element.

This disclosure also relates to a facility for welding two opposite edges of two pieces, including a welding head, a weld protecting device according to the disclosure herein, wherein the welding head is mounted on the front element of the weld protecting device, and including a system for guiding the protecting device along the opposite edges of the pieces to be welded.

Preferably, the guiding system comprises or consists of two guides arranged on either side of the opposite edges of the pieces to be welded, each guide including an edge in proximity to the opposite edges of the pieces to be welded which is of a similar profile to the profile of the edges of the pieces to be welded.

Preferably, the edge of each guide is bevelled.

### BRIEF DESCRIPTION OF THE DRAWINGS

Further characteristics and advantages of the disclosure herein will appear upon reading the following detailed description for the understanding of which the appended figures will be referred to, in which:

FIG. 1 is a cross-section view along a vertical longitudinal plane of a weld protecting device according to the disclosure herein;

FIG. 2 is a top view of the weld protecting device represented in FIG. 1;

FIG. 3 is an exploded schematic representation of the weld protecting device represented in FIG. 1;

FIG. 4 is a cross-section view along a transverse vertical plane of a welding facility fitted with the weld protecting device represented in FIGS. 1 and 2; and

FIG. 5 is a perspective schematic representation of the welding facility represented in FIG. 4, showing the side guides of the protecting device according to the disclosure herein.

### DETAILED DESCRIPTION

For the description of the disclosure herein, the vertical, longitudinal and transverse orientations along the reference frame V, L, T indicated in the figures will be adopted by way of non-limiting examples.

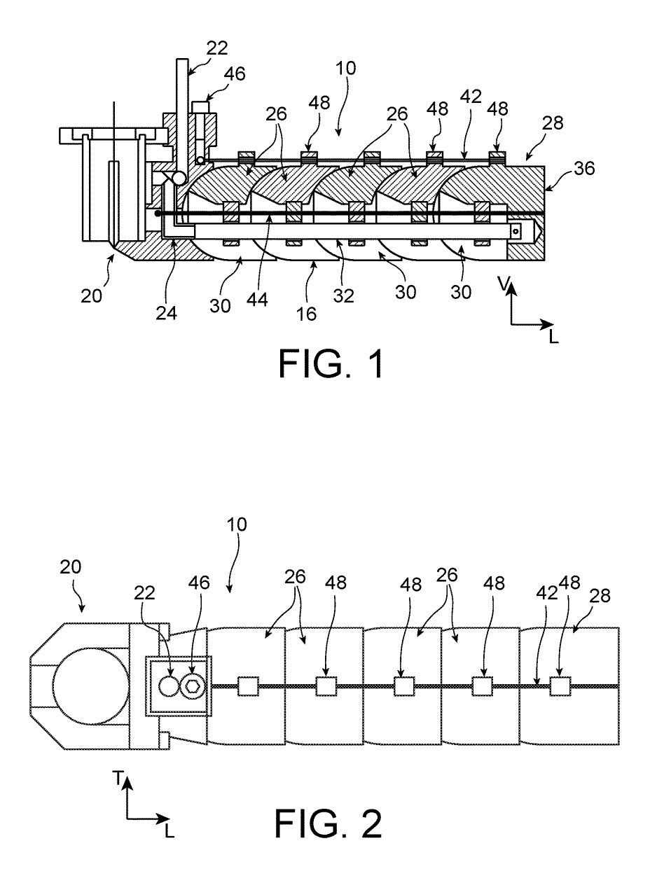

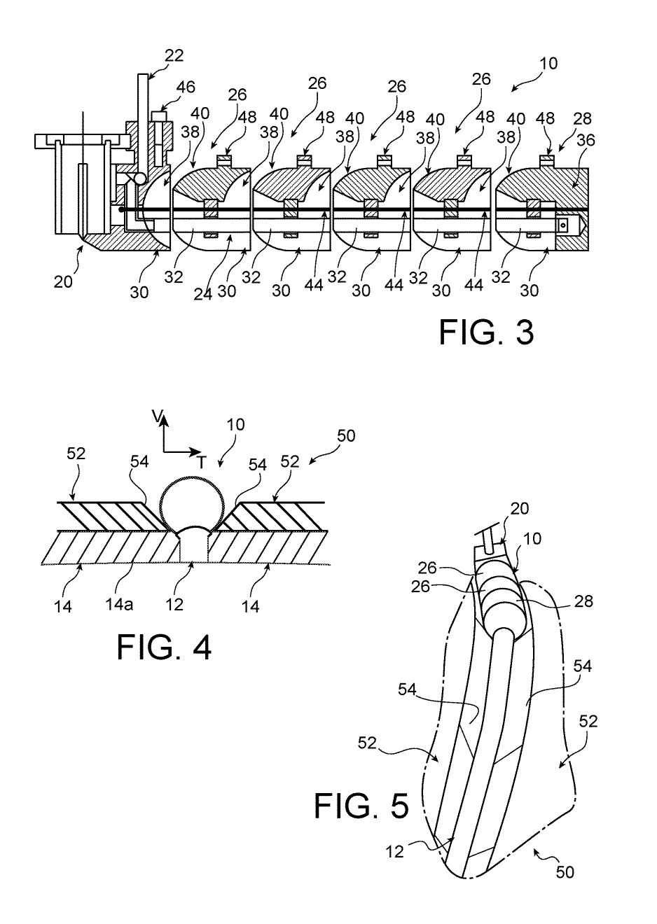

The front to back orientation will also be adopted as being the longitudinal direction and the left to right orientation reporting to FIG. 1, and the top to bottom orientation as being the vertical direction and from top to bottom reporting to FIG. 1.

A weld protecting device 10 is illustrated, which is intended to protect a weld bead 12 (FIG. 4) connecting two pieces 14 to each other, during the welding process.

The protecting device 10 comprises or consists of an elongate element which is positioned above the weld bead 12 and which moves along the weld bead 12 as it is formed, to prevent the oxidization of the material making up the weld bead 12.

The protecting device 10 includes a chamber 16 which is open in the lower part of the protecting device 10, to open into the weld bead.

An inert gas, such as for example helium or argon supplies this chamber 16 and is diffused towards the weld bead 12, consequently avoiding any contact of the molten metal with the oxygen from ambient air.

The protecting device 10 is intended to be implemented to protect weld beads having any geometry, that is a rectilinear or curved weld bead 12, that is a circular or variably curved weld bead.

The protecting device 10 is consequently made of several elements which are hinged to each other and which are arranged following each other, making an alignment.

The protecting device 10 thus includes a front element 20, or head element, which is located at a first end of the protecting device 10.

The head element 20 is associated with the welding head (not represented) which is used to form the weld bead, and it includes structure for connecting it with an attached component of the welding facility, for holding the head element 20 in place during the welding operation. According to a preferred embodiment of the protecting device 10, the head element 20 is connected to the welding head by a pivot connection about a main vertical axis of the welding head.

The head element 20 also includes a tip 22 and a duct 24 for connecting the chamber 16 to an inert gas supply.

The protecting device 10 also includes intermediate elements 26 which are mounted one following the other and following the head elements 20 and a rear back element 28 which is mounted following the last intermediate element 26.

Each element 20, 26 and 28 includes a hollow housing 30 which forms part of the chamber 16. The housing 30 of an element 20, 26, 28 is consequently open downwards, towards the weld bead 12.

Each housing 30 of an element 20, 26, 28 is further open towards the housing 30 of each element 20, 26, 28 adjacent to the element 20, 26, 28 in which the housing 30 is formed. The housings 30 thus communicate with each other and form a single cavity making up the chamber 16.

The housings 30 of the intermediate elements 26 are thus open downwards, forwards and backwards, whereas the housings of the back element 28 is open downwards and forwards.

The back element 28 includes a transverse vertical back plate 36 for closing the back end thereof.

A tubular braid 32 extends the duct 24 of the head element 20 towards the other elements 26, 28. This tubular braid 32 is permeable to the inert gas, which enables a better gas distribution in the housings of the elements 26, 28.

According to further embodiments of the protecting device 10, the latter does not include any tubular braid 32. Gas diffusion in the housings of the elements 26, 28 is only made through the duct 24 of the head element 20 which leads toward the housings of the elements 26, 28.

The protecting device 10 is made so as to adapt to the geometry of the weld to be made, that is to the shape of the edges of the pieces to be welded.

To do so, each element 20, 26, 28 of the protecting device 10 is hinged relative to each element 20, 26, 28 adjacent thereto.

The hinge of two adjacent elements 20, 26, 28 comprises or consists of a swivel connection, enabling both elements to be relatively moved in every direction.

This hinge includes a hemispherical shaped housing 38 which is formed in a first one of both elements, and which longitudinally leads towards the second of both elements. The hinge also includes an insert 40 which is also of a hemispherical shape and dimensions complementary to the dimensions of the hemispherical housing 38, that is having the same diameter.

The insert 40 is formed in the second of both elements and it is oriented towards the first of both elements. The insert 40 is thus accommodated inside the associated hemispherical housing 38 and it is rotatably free about their common center.

Here, according to the embodiment represented in the figures, the hemispherical housing 38 is longitudinally open backwards and the insert 40 is oriented forwards.

Also, in the protecting device 10, each intermediate element 26 includes a hemispherical housing 38 at one longitudinal end, here the back longitudinal end, and it also includes an insert 40 at the other longitudinal end, here the front longitudinal end.

Moreover, all the intermediate elements 26 are identical, that is each of them includes a hemispherical housing and an insert 40.

The front element 20, in turn, only includes a hemispherical housing 38 which is intended to accommodate the insert 40 of the longitudinally front most intermediate element and the back element includes an insert 40 which is accommodated in the hemispherical housing 38 of the longitudinally rearmost intermediate element.

The elements 20, 26, 28 are held in a position mated to each other, that is each insert 40 is longitudinally held in the associated hemispherical housing 38, through cables 42, 44.

Each cable 42, 44 extends along the protecting device 10 and it is connected to each element. Each end of the cables 42, 44 is attached to the front element 20 or to the back element 28, for example through tightening screws 46.

A first cable 42 extends above the intermediate elements 26 and each intermediate element 26 includes an upper snug 48 which is perforated and which through which the first cable 42 passes.

The second cable 44 extends through each element of the protecting device 10, preferably through the housing 30 of each element.

Thus, all the elements of the protecting device are free to pivot relative to each other along any direction, which enables the protecting device 10 to assume any configuration and at any time during a step of welding pieces 14.

Thus, when the protecting device 10 is deformed, this means that some or all the elements pivot relative to each other, either one of both cables 42, 44 is freely deformed, whereas the other cable 42, 44 remains tensioned, thus preventing each insert 40 of a element 26, 28 from coming out of the associated hemispherical housing 38.

According to an alternative embodiment of the protecting device 10, the hinge of two adjacent elements 20, 26, 28 comprises or consists of a pivot hinge, enabling the two adjacent elements to freely pivot relative to each other about the pivot axis.

According to a first embodiment of this alternative, the pivot axis is vertical, which enables planar surfaces for which the weld bead is curved to be welded.

According to a second embodiment of this alternative, the pivoting axis is horizontal, which enables bent pieces 14 to be welded.

Since the elements 20, 26, 28 of the protecting device 10 are free to move relative to each other, it is preferable to guide them during the movement of the protecting device relative to the pieces 14 to be welded, along the weld bead 12. This makes it possible to avoid that they contact the weld bead and this also optimises protection.

Such a solution is particularly advantageous in the case of a neither rectilinear nor circular weld bead (for example a sinusoidal or helical bead).

The facility represented in FIGS. 4 and 5 includes a system 50 for guiding the protecting device 10 along the weld bead 12.

This guiding system 50 is made of two side guides 52 which are provided on either side of the opposite edges 14a of both pieces 14 to be welded, the edges 14a at which the weld bead is made.

These guides 52 here comprise or consist of two plates each of which is mounted on a piece to be welded, and the edge 54 of a guide 52 of which is located in proximity to and distant from the edge 14a of the associated piece 14 to be welded.

This distance between the respective edges 14a, 54 of the piece 14 to be welded and of the guide 52 associated thereto is defined as a function of the width of the protecting device. This affords to have a distance between the opposite edges 54 of the guides 52 substantially equal to the width of the protecting device 10.

The distance between the edge 54 of a guide 52 and the edge 14a of the associated piece 14 is constant throughout the edge 14a to be welded.

Thus, if the edge 14a of the piece 14 is non rectilinear, as previously mentioned, for a non rectilinear weld bead 12, the edge 54 of the guide 52 is also non rectilinear and thus has the same profile as the edge 14a of the piece 14 and therefore the same curvature as the weld bead 12 which will be made.

Thus, in order to promote guiding of the protecting device, the edges 54 of the guides 52 are bevelled.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for protecting a weld by gaseous diffusion including several elements mounted one after another and hinged to each other, and including, from a front end to a back end according to alignment of the elements:
a front element to accommodate a welding head;
intermediate elements mounted one after another and behind the front element,
a back element mounted behind a last intermediate element,
each element including a housing open downwards and towards each other adjacent element, all the housings forming a gas diffusion chamber which is connected to a protection gas supply source;
wherein two adjacent elements are hinged to each other and are free to pivot relative to each other,
and wherein the two adjacent elements are hinged to each other by a swivel connection, and are free to pivot relative to each other along any direction.

2. The protecting device according to claim 1, wherein a first element among the two adjacent elements includes a hemispherical shaped housing which is open towards the second element of the two adjacent elements and the second element includes an insert with a hemispherical shape complementary to the hemispherical housing of the first element, and the insert is accommodated in the hemispherical housing of the first element.

3. The protecting device according to claim 2, wherein a first end of each intermediate element includes a hemispherical housing and a second end of the intermediate element includes a hemispherical shaped insert.

4. The protecting device according to claim 2, wherein the front end includes a hemispherical housing in which the insert of the adjacent intermediate element is accommodated and the back element includes an insert which is accommodated in the hemispherical housing of the adjacent intermediate element.

5. The protecting device according to claim 2, comprising a holder to hold the insert of each element in the hemispherical housing of the adjacent element.

6. The protecting device according to claim 5, comprising at least one link-forming cable which is attached to the front element and to the back element and which cooperates with each intermediate element, to prevent any forward or backward deviation of the elements from each other.

7. The protecting device according to claim 6, comprising two cables vertically offset from each other, each end of each cable attached to the front element or to the back element and a segment of each cable connected to an intermediate element.

8. A facility for welding two opposite edges of two pieces, including a welding head, a weld protecting device according to claim 1, wherein the welding head is mounted on the front element of the weld protecting device, and including a system for guiding the protecting device along opposite edges of the pieces to be welded.

9. The facility according to claim 8, wherein the guiding system comprises two guides arranged on either side of the opposite edges of the pieces to be welded, each guide including an edge in proximity to the opposite edges of the pieces to be welded which has a similar profile to the profile of the edges of the pieces to be welded.

10. The facility according to claim 9 wherein the edge of each guide is bevelled.
